(19) United States
(12) Patent Application Publication
(10) Pub. No.: US 2012/0110101 A1
(43) Pub. Date: May 3, 2012

(54) METHOD FOR EFFICIENT CREATION OF E-MAIL TRAFFIC

(76) Inventor: Ulf Feistel, Laasdorf (DE)

(21) Appl. No.: 13/281,584

(22) Filed: Oct. 26, 2011

(30) Foreign Application Priority Data
Oct. 27, 2010 (DE) 10 2010 049 624.3

(51) Int. Cl. G06F 15/16

(52) U.S. Cl. 709/206

(57) ABSTRACT

A method for efficiently handling e-mail traffic using an e-mail system includes sending an e-mail and a weighting and status table stored with the e-mail to a recipient. The weighting and status table includes a weighting, entered and selected by the sender, that pertains to the e-mail. An assessment of the weighting selected by the sender is received from the recipient of the e-mail. The assessment is entered into the weighting and status table as a statistical quantity so as to provide an updated weighting and status table. At least a diverging assessment is made available to the sender based on the updated weighting and status table. The previous weighting and status table is overwritten with the updated weighting and status table, which is provided to the sender for entering another weighting upon creation of a new e-mail for the same recipient.

### CROSS REFERENCE TO RELATED APPLICATIONS

This application claims priority to German Patent Application No. DE 10 2010 049 624.3, filed Oct. 27, 2010.

### FIELD

The present invention relates to the handling of e-mail traffic between senders and recipients of e-mail.

### BACKGROUND

With the ongoing advances and dissemination of computer and information systems as well as the associated network technologies such as, for instance, wireless communication and Internet communication, ever-larger volumes of electronic information are being communicated, transmitted and subsequently processed by users and/or systems. An example includes the electronic e-mail programs that have become a popular application among computer users for composing and receiving such information. With the advent of the Internet, sending and receiving e-mails, for example, have become such an important factor that this has a considerable influence on the decision of many people as to whether to buy a computer. In many company environments, e-mail has now become the de-facto standard modality used by co-workers to exchange information among each other.

An Internet e-mail consists of the header and the body. The header only contains the mandatory components, namely, the sender and the date of creation of the e-mail. Moreover, the header of an e-mail can contain several optional items of information. As a rule, there is information about the route taken by the e-mail, about the content of the message and its format as well as information about recipients.

The increased popularity of e-mail and other systems for information transmission, however, also gave rise to the first problems regarding the management and processing of increased volumes of information stemming from a wide array of sources.

One of these problems is that many users now find themselves confronted with a veritable flood of e-mails and other information that then need to be sorted and/or answered, as a result of which the ability to send, receive and process information has almost become a hindrance for their own productivity. In fact, since 2002, more than 50%, and since 2007, more than 90% of the worldwide e-mail volume consisted of spam.

In view of the large number of e-mails and other electronic information, it has become a difficult undertaking to manage information in such a manner as to decide what is important and what is not, without having to invest a great deal of valuable time to personally determine the level of importance. As an example of these determinations, users might have to decide whether messages have to be answered right away, skipped so that they can be read at a later point in time, or whether they should simply be deleted since they are not important (junk mail, for example).

Various attempts have been made to overcome the problems associated with managing information. Thus, for instance, attempts were made with an eye towards reducing the volume of junk mail or electronic advertising mail that users receive. In addition to this, some e-mail programs provide rules that stipulate which e-mails are to be managed within the program.

Efforts to limit certain types of information, however, usually do not eliminate the underlying problem that lies behind systems that transmit and receive e-mail and other information. This means that conventional systems often instruct e-mail recipients to manually review and check at least some, if not all, of the received messages in order to determine which messages should be read or processed further. As has already been discussed above, this takes up time that is intended for other, more productive tasks. Consequently, in view of the huge volumes of received information, there is a need for a system and a method to make it easier to process e-mail efficiently.

International patent application WO 99 67731 A1 describes a concept for detecting junk mail utilizing a probabilistic classifier.

European patent specification EP 0 420 779 B1 describes an electronic mail-management method. Here, the messages are appropriately grouped after being received, and are then stored in different inboxes.

### SUMMARY

In an embodiment, the present invention provides a method for efficiently handling e-mail traffic using an e-mail system that includes sending an e-mail and a weighting and status table stored with the e-mail to a recipient. The weighting and status table includes a weighting, entered and selected by the sender, that pertains to the e-mail. An assessment of the weighting selected by the sender is received from the recipient of the e-mail. The assessment is entered into the weighting and status table as a statistical quantity so as to provide an updated weighting and status table. At least a diverging assessment is made available to the sender based on a transmission of the updated weighting and status table. The previous weighting and status table is overwritten with the updated weighting and status table, which is provided to the sender for entering another weighting upon creation of a new e-mail for the recipient.

### DETAILED DESCRIPTION

In an embodiment, the present invention provides a modality to efficiently process incoming e-mail or other messages within a system, especially by the recipient.

An embodiment of the present invention provides a method for efficiently handling e-mail traffic, comprising the following steps:

a) together with the e-mail, the sender of the e-mail stores a weighting and status table in which he/she has entered a weighting pertaining to the e-mail,

b) the recipient of the e-mail checks and assesses the weighting selected by the sender and enters this as a statistical quantity into the weighting and status table,

c) at least a diverging assessment is made available to the sender by transmitting the updated weighting and status table, whereby the e-mail system overwrites the previous version of the weighting and status table, so that, when an e-mail is once again created for the same recipient, the weighting is now entered into the updated weighting and status table.

It is advantageous if the e-mail system of the sender does not send the e-mail until the weighting and status table has been created by the sender. In this manner, the sender is forced to undertake an assessment regarding the priority of the information that he/she is going to transmit.

It is likewise advantageous if, every time an e-mail is received, the e-mail system of the recipient first checks whether it contains a weighting and status table from the sender. If it does not contain a weighting and status table, the system then checks whether this is a first-time contact with this sender and thus a weighting and status table could not yet have been incorporated into the e-mail system of the sender. In such a case, the e-mail system of the recipient automatically sends a weighting and status table to the sender so that it can be incorporated into his/her e-mail system for the first time. For the rest, the e-mail is accepted. However, if it is ascertained that that sender has already contacted the recipient several times, the e-mail system does not accept the received e-mail and indicates to the sender that the e-mail has been rejected because no weighting and status table was transmitted.

One advantage of an embodiment of the invention is the fact that the e-mail system of every receiver only places a received e-mail into the inbox of the recipient if a weighting and status table has been transmitted along with it.

In another favorable embodiment of an e-mail system, the incoming-mail folder contains either subfolders or folders that are on the same level as the incoming-mail folder, and the number of folders and their order correspond to the possible priority levels, so that the e-mails with a given priority level are placed into the appropriate folders by the e-mail system. Consequently, the recipient can easily select the appropriate folder that corresponds to a given priority level in order to process the e-mails there.

Another advantage of an embodiment of the invention is that the sender is automatically blocked by the e-mail system of the recipient after a certain number of erroneous weightings, whereby said number can be set as desired. In this context, it can be provided that the sender can only have the block removed by personally contacting the recipient. Advantageously, the e-mail system incorporates the weighting and status table into the header of the e-mail. Therefore, in a very simple manner, this ensures that the weighting by the sender is automatically displayed to the recipient.

In another advantageous embodiment, every time a new e-mail is composed, the assessment of the recipient in question is automatically displayed in the form of a visual and/or acoustic signal.

The invention can be realized particularly advantageously in so-called intranets, since each member can be provided with a weighting and status table right from the start. The invention, however, is not restricted to a closed system. In an open system such as the Internet, for example, the mail recipient can enter a criterion that is pre-programmed in the standard software which, at the time of the next e-mail contact, requires the recipient to prompt the sender to provide the weighting and status table, along with the information that the e-mail will only be accepted if it is accompanied by a filled-out weighting and status table.

The weighting and status table contains at least two tables that have to be filled out. Here, the first one is filled out by the sender while the second one is filled out by the recipient. In the simplest of cases, the tables are displayed. However, it is advantageous if the information from these tables is presented visually and/or acoustically. Thus, for instance, the summary assessment of the recipient about the correct or incorrect weighting by the sender can be displayed in a bar chart. In contrast, when the sender classifies the priority, it is not the entire table but rather only the envisaged classification that is shown to the recipient. This likewise conceals a great deal of information that would just take time if all of the parties involved had to read it.

An advantageous characteristic of embodiments of the invention is the iterative process between the sender and the recipient of e-mails, especially in order to provide the recipient with an efficient way to exert an influence on senders who, up until now, had classified the information, or the priority of the information to be sent out, exclusively on the basis of their own opinions, without considering whether such a classification of the priority is, in fact, accurate from the standpoint of the recipient.

The invention will be explained in greater detail below on the basis of particular embodiments.

In the embodiment below, it is assumed that it involves internal e-mail traffic in a closed organizational unit, for instance, a company. Thus, it is supposed to be a typical intranet. As is commonly the case for closed organizational units, rules are stipulated to which all of the users must adhere. In such a system, it can be generally assumed that everybody has the possibility of communicating with everybody else. A weighting and status table is integrated into every e-mail system of each member so that the flood of daily e-mails can be handled efficiently. The weighting and status table here contains essentially two tables. A first table serves to classify the content of the e-mail that is to be sent or the priority with which the recipient has to deal with the information. Possible priority levels can be as follows:
only for information purposes, no need to deal with this
only for information purposes
for purposes of completing the documentation
for your information, definitely to be read at your convenience
for your information, disregard if not read by mm.dd.yyyy!
please handle—respond by mm.dd.yyyy
urgent, handle immediately
urgent, read immediately, no response necessary
documentation for meeting on mm.dd.yyyy at hh:mm

Each e-mail system is now set in such a way by the software that, at the latest when an e-mail is sent, the first table opens and the sender can only send the e-mail if he/she selects one of the priority levels corresponding to the information he/she is going to send. Only then is the e-mail released for being sent, a process in which the weighting and status table is sent along with it. It is very easy to include the weighting and status table in the header since an e-mail consists of two parts, namely, the header and the body with the actual text. The e-mail system of the recipient checks the weighting and status table and only displays the selected priority level. The display can consist exclusively of the text. However, it is advantageous if color gradations are employed to show the priority level, for instance, in such a way that less important information is shown with a green background, with a transition going all the way to a red background for very important information. In another advantageous configuration of an e-mail system, the incoming-mail folder contains either subfolders or folders that are on the same level as the incoming-mail folder, and the number of folders and their order correspond to the possible priority levels, so that the e-mails with a given priority level are placed into the appropriate folders by the e-mail system. Consequently, the recipient can easily select the appropriate folder that corresponds to a given priority level in order to process the e-mails there.

Particularly in order to prevent misuse of the selection that can be made of the priority level that is to be indicated, the selected priority level is checked by the recipient. In a second table, which is likewise an integral part of the weighting and status table, the recipient then has the possibility of indicating his/her assessment of the weighting given by the sender. Three useful options that can be entered are the following:
correct classification
incorrect classification, namely, overestimation of the priority
incorrect classification, namely, underestimation of the priority

The classification selected is transmitted to the sender through the transmission of the now newly generated weighting and status table, as a result of which the weighting and status table that had been stored in the sender's e-mail system up until then is overwritten. The transmission to the sender can take place every time an assessment is carried out or else only when the recipient has made a divergent assessment. The second table is used to perform a statistical evaluation that is then displayed. Each e-mail system is capable of generating and showing the display for each addressee. In the simplest case, the statistical evaluation consists of a bar chart that is displayed. Initially, the bar chart consists of a red section and of a green section of the same size. Each incorrect assessment causes the red section to become larger and the green section to become correspondingly smaller. In the simplest case, a correct assessment has the opposite effect, namely, that the green section increases while the red section decreases. Since this is an iterative process between the sender classifications and the recipient classifications, it can also be statistically taken into consideration that later classifications count differently from, for example, the first-time classifications since one can assume that, over the course of frequent e-mail traffic, the sender will increasingly adapt his/her classifications to the habits of the recipient. The bar chart can also be in the form of a pie chart. Fundamentally speaking, any design is conceivable that depicts two states in an easily recognizable form, whereby a change in one of the states is always associated with an inversely proportional change in the other state. Any geometrical shapes as well as color designs are conceivable in this context. It is worth mentioning that the number of maximally permitted incorrect assessments can be prescribed, so that, when the prescribed number is reached, the recipient automatically blocks that sender. The consequence of this is that that sender can no longer send e-mails to that recipient. A release is only possible following an active step by the recipient in that either the maximally permitted number is increased or in that the incorrect assessments are deleted. The release should advantageously only be possible following personal contact with the recipient. However, a field can also be provided in the first weighting and status table containing the following text:
please reset the classification
   so that the sender is given the possibility of asking the recipient to refrain from implementing the impending block before it occurs.

In an advantageous embodiment, the statistical evaluation is linked in such a way that a simple click of the mouse, for example, onto the incorrectly assessed section, opens all e-mails, and the sender, without having to search all of the e-mails, can then relatively easily examine his/her incorrect assessments in order to improve his/her future weightings.

The learning process can also be further improved if a column is provided in the first weighting and status table into which the recipient enters his/her weighting, in addition to the assessment in the second table, which, however, shows only statistically underestimated or overestimated values. This assessment in the first table of the sender and now also of the recipient can be displayed to the sender if he/she calls up the incorrectly classified e-mails, for example, by clicking onto the incorrectly assessed section. In this manner, the sender can better adapt to the requirements of the recipient.

The invention, however, is likewise possible to the same extent in an open system such as the Internet. The only difference here is that it will additionally involve providing each sender with the option to generate a weighting and status table. In the simplest case, a recipient whose e-mail system has ascertained that no weighting and status table was received with the e-mail can be prompted to send such a weighting and status table to the sender, along with the request that the weighting be entered into the weighting and status table, either already for this instance, or else for all future e-mails. Otherwise, it could have the consequence that the recipient will no longer accept e-mails from this sender.

While the invention has been particularly shown and described with reference to preferred embodiments thereof, it will be understood by those skilled in the art that various changes in form and details may be made therein without departing from the spirit and scope of the invention.

### Method for Efficiently Handling E-Mail Traffic

The present invention relates to the handling of e-mail traffic between senders and recipients of e-mail.

With the ongoing advances and dissemination of computer and information systems as well as the associated network technologies such as, for instance, wireless communication and Internet communication, ever-larger volumes of electronic information are being communicated, transmitted and subsequently processed by users and/or systems. An example includes the electronic e-mail programs that have become a popular application among computer users for composing and receiving such information. With the advent of the Internet, sending and receiving e-mails, for example, have become such an important factor that this has a considerable influence on the decision of many people as to whether to buy a computer. In many company environments, e-mail has now become the de-facto standard modality used by co-workers to exchange information among each other.

An Internet e-mail consists of the header and the body. The header only contains the mandatory components, namely, the sender and the date of creation of the e-mail. Moreover, the header of an e-mail can contain several optional items of information. As a rule, there is information about the route taken by the e-mail, about the content of the message and its format as well as information about recipients.

The increased popularity of e-mail and other systems for information transmission, however, also gave rise to the first problems regarding the management and processing of increased volumes of information stemming from a wide array of sources.

One of these problems is that many users now find themselves confronted with a veritable flood of e-mails and other information that then need to be sorted and/or answered, as a result of which the ability to send, receive and process information has almost become a hindrance for their own productivity. In fact, since 2002, more than 50%, and since 2007, more than 90% of the worldwide e-mail volume consisted of spam.

In view of the large number of e-mails and other electronic information, it has become a difficult undertaking to manage information in such a manner as to decide what is important and what is not, without having to invest a great deal of valuable time to personally determine the level of importance. As an example of these determinations, users might have to decide whether messages have to be answered right away, skipped so that they can be read at a later point in time, or whether they should simply be deleted since they are not important (junk mail, for example).

Various attempts have been made to overcome the problems associated with managing information. Thus, for instance, attempts were made with an eye towards reducing the volume of junk mail or electronic advertising mail that users receive. In addition to this, some e-mail programs provide rules that stipulate which e-mails are to be managed within the program.

Efforts to limit certain types of information, however, usually do not eliminate the underlying problem that lies behind systems that transmit and receive e-mail and other information. This means that conventional systems often instruct e-mail recipients to manually review and check at least some, if not all, of the received messages in order to determine which messages should be read or processed further. As has already been discussed above, this takes up time that is intended for other, more productive tasks. Consequently, in view of the huge volumes of received information, there is a need for a system and a method to make it easier to process e-mail efficiently.

International patent application WO 99 67731 A1 discloses a concept for detecting junk mail utilizing a probabilistic classifier.

European patent specification EP 0 420 779 B1 describes an electronic mail-management method. Here, the messages are appropriately grouped after being received, and are then stored in different inboxes.

The invention is based on the objective of putting forward a modality to efficiently process incoming e-mail or other messages within a system, especially by the recipient.

This objective is achieved by means of a method for efficiently handling e-mail traffic, comprising the following steps:

a) together with the e-mail, the sender of the e-mail stores a weighting and status table in which he/she has entered a weighting pertaining to the e-mail,

b) the recipient of the e-mail checks and assesses the weighting selected by the sender and enters this as a statistical quantity into the weighting and status table,

c) at least a diverging assessment is made available to the sender by transmitting the updated weighting and status table, whereby the e-mail system overwrites the previous version of the weighting and status table, so that, when an e-mail is once again created for the same recipient, the weighting is now entered into the updated weighting and status table.

It is advantageous if the e-mail system of the sender does not send the e-mail until the weighting and status table has been created by the sender. In this manner, the sender is forced to undertake an assessment regarding the priority of the information that he/she is going to transmit.

It is likewise advantageous if, every time an e-mail is received, the e-mail system of the recipient first checks whether it contains a weighting and status table from the sender. If it does not contain a weighting and status table, the system then checks whether this is a first-time contact with this sender and thus a weighting and status table could not yet have been incorporated into the e-mail system of the sender. In such a case, the e-mail system of the recipient automatically sends a weighting and status table to the sender so that it can be incorporated into his/her e-mail system for the first time. For the rest, the e-mail is accepted. However, if it is ascertained that that sender has already contacted the recipient several times, the e-mail system does not accept the received e-mail and indicates to the sender that the e-mail has been rejected because no weighting and status table was transmitted.

One advantage of the invention is precisely the fact that the e-mail system of every receiver only places a received e-mail into the inbox of the recipient if a weighting and status table has been transmitted along with it.

In another favorable embodiment of an e-mail system, the incoming-mail folder contains either subfolders or folders that are on the same level as the incoming-mail folder, and the number of folders and their order correspond to the possible priority levels, so that the e-mails with a given priority level are placed into the appropriate folders by the e-mail system. Consequently, the recipient can easily select the appropriate folder that corresponds to a given priority level in order to process the e-mails there.

Another advantage of the invention is that the sender is automatically blocked by the e-mail system of the recipient after a certain number of erroneous weightings, whereby said number can be set as desired. In this context, it can be provided that the sender can only have the block removed by personally contacting the recipient. Advantageously, the e-mail system incorporates the weighting and status table into the header of the e-mail. Therefore, in a very simple manner, this ensures that the weighting by the sender is automatically displayed to the recipient.

In another advantageous embodiment, every time a new e-mail is composed, the assessment of the recipient in question is automatically displayed in the form of a visual and/or acoustic signal.

The invention can be realized particularly advantageously in so-called intranets, since each member can be provided with a weighting and status table right from the start. The invention, however, is not restricted to a closed system. In an open system such as the Internet, for example, the mail recipient can enter a criterion that is pre-programmed in the standard software which, at the time of the next e-mail contact, requires the recipient to prompt the sender to provide the weighting and status table, along with the information that the e-mail will only be accepted if it is accompanied by a filled-out weighting and status table.

The weighting and status table contains at least two tables that have to be filled out. Here, the first one is filled out by the sender while the second one is filled out by the recipient. In the simplest of cases, the tables are displayed. However, it is advantageous if the information from these tables is presented visually and/or acoustically. Thus, for instance, the summary assessment of the recipient about the correct or incorrect weighting by the sender can be displayed in a bar chart. In contrast, when the sender classifies the priority, it is not the entire table but rather only the envisaged classification that is shown to the recipient. This likewise conceals a great deal of information that would just take time if all of the parties involved had to read it.

In summary, the essence of the invention is the iterative process between the sender and the recipient of e-mails, especially in order to provide the recipient with an efficient way to exert an influence on senders who, up until now, had classified the information, or the priority of the information to be sent out, exclusively on the basis of their own opinions, without considering whether such a classification of the priority is, in fact, accurate from the standpoint of the recipient.

The invention will be explained in greater detail below on the basis of embodiments.

In the embodiment below, it is assumed that it involves internal e-mail traffic in a closed organizational unit, for instance, a company. Thus, it is supposed to be a typical intranet. As is commonly the case for closed organizational units, rules are stipulated to which all of the users must adhere. In such a system, it can be generally assumed that everybody has the possibility of communicating with everybody else. A weighting and status table is integrated into every e-mail system of each member so that the flood of daily e-mails can be handled efficiently. The weighting and status table here contains essentially two tables. A first table serves to classify the content of the e-mail that is to be sent or the priority with which the recipient has to deal with the information. Possible priority levels can be as follows:
only for information purposes, no need to deal with this
only for information purposes
for purposes of completing the documentation
for your information, definitely to be read at your convenience
for your information, disregard if not read by mm.dd.yyyy!
please handle—respond by mm.dd.yyyy
urgent, handle immediately
urgent, read immediately, no response necessary
documentation for meeting on mm.dd.yyyy at hh:mm

Each e-mail system is now set in such a way by the software that, at the latest when an e-mail is sent, the first table opens and the sender can only send the e-mail if he/she selects one of the priority levels corresponding to the information he/she is going to send. Only then is the e-mail released for being sent, a process in which the weighting and status table is sent along with it. It is very easy to include the weighting and status table in the header since an e-mail consists of two parts, namely, the header and the body with the actual text. The e-mail system of the recipient checks the weighting and status table and only displays the selected priority level. The display can consist exclusively of the text. However, it is advantageous if color gradations are employed to show the priority level, for instance, in such a way that less important information is shown with a green background, with a transition going all the way to a red background for very important information. In another advantageous configuration of an e-mail system, the incoming-mail folder contains either subfolders or folders that are on the same level as the incoming-mail folder, and the number of folders and their order correspond to the possible priority levels, so that the e-mails with a given priority level are placed into the appropriate folders by the e-mail system. Consequently, the recipient can easily select the appropriate folder that corresponds to a given priority level in order to process the e-mails there.

Particularly in order to prevent misuse of the selection that can be made of the priority level that is to be indicated, the selected priority level is checked by the recipient. In a second table, which is likewise an integral part of the weighting and status table, the recipient then has the possibility of indicating his/her assessment of the weighting given by the sender. Three useful options that can be entered are the following:
correct classification
incorrect classification, namely, overestimation of the priority
incorrect classification, namely, underestimation of the priority

The classification selected is transmitted to the sender through the transmission of the now newly generated weighting and status table, as a result of which the weighting and status table that had been stored in the sender's e-mail system up until then is overwritten. The transmission to the sender can take place every time an assessment is carried out or else only when the recipient has made a divergent assessment. The second table is used to perform a statistical evaluation that is then displayed. Each e-mail system is capable of generating and showing the display for each addressee. In the simplest case, the statistical evaluation consists of a bar chart that is displayed. Initially, the bar chart consists of a red section and of a green section of the same size. Each incorrect assessment causes the red section to become larger and the green section to become correspondingly smaller. In the simplest case, a correct assessment has the opposite effect, namely, that the green section increases while the red section decreases. Since this is an iterative process between the sender classifications and the recipient classifications, it can also be statistically taken into consideration that later classifications count differently from, for example, the first-time classifications since one can assume that, over the course of frequent e-mail traffic, the sender will increasingly adapt his/her classifications to the habits of the recipient. The bar chart can also be in the form of a pie chart. Fundamentally speaking, any design is conceivable that depicts two states in an easily recognizable form, whereby a change in one of the states is always associated with an inversely proportional change in the other state. Any geometrical shapes as well as color designs are conceivable in this context. It is worth mentioning that the number of maximally permitted incorrect assessments can be prescribed, so that, when the prescribed number is reached, the recipient automatically blocks that sender. The consequence of this is that that sender can no longer send e-mails to that recipient. A release is only possible following an active step by the recipient in that either the maximally permitted number is increased or in that the incorrect assessments are deleted. The release should advantageously only be possible following personal contact with the recipient. However, a field can also be provided in the first weighting and status table containing the following text:
please reset the classification
   so that the sender is given the possibility of asking the recipient to refrain from implementing the impending block before it occurs.

In an advantageous embodiment, the statistical evaluation is linked in such a way that a simple click of the mouse, for example, onto the incorrectly assessed section, opens all e-mails, and the sender, without having to search all of the e-mails, can then relatively easily examine his/her incorrect assessments in order to improve his/her future weightings.

The learning process can also be further improved if a column is provided in the first weighting and status table into which the recipient enters his/her weighting, in addition to the assessment in the second table, which, however, shows only statistically underestimated or overestimated values. This assessment in the first table of the sender and now also of the recipient can be displayed to the sender if he/she calls up the incorrectly classified e-mails, for example, by clicking onto the incorrectly assessed section. In this manner, the sender can better adapt to the requirements of the recipient.

The invention, however, is likewise possible to the same extent in an open system such as the Internet. The only difference here is that it will additionally involve providing each sender with the option to generate a weighting and status table. In the simplest case, a recipient whose e-mail system has ascertained that no weighting and status table was received with the e-mail can be prompted to send such a weighting and status table to the sender, along with the request that the weighting be entered into the weighting and status table, either already for this instance, or else for all future e-mails. Otherwise, it could have the consequence that the recipient will no longer accept e-mails from this sender

1-10. (canceled)

11. A method for efficiently handling e-mail traffic using an e-mail system, the method comprising:
sending an e-mail and a weighting and status table stored with the e-mail to a recipient, the weighting and status table including a weighting, entered and selected by a sender, pertaining to the e-mail;
receiving, from a recipient of the e-mail, an assessment of the weighting selected by the sender, the assessment being entered into the weighting and status table as a statistical quantity so as to provide an updated weighting and status table; and
making at least a diverging assessment available to the sender based on a transmission of the updated weighting and status table, and overwriting the weighting and status table with the updated weighting and status table so as to provide the updated weighting and status table to the sender for entering another weighting upon a creation of a new e-mail for the recipient.

12. The method recited in claim 11, wherein the e-mail system does not send the e-mail until the weighting and status table has been created by the sender.

13. The method recited in claim 11, wherein an e-mail system of the recipient performs a check to determine if the e-mail includes a weighting and status table from the recipient.

14. The method recited in claim 13, wherein the e-mail system of the recipient sends a weighting and status table to the sender for a first time so as to be incorporated into the e-mail system of the sender if the check determines that no weighting and status table was transmitted.

15. The method recited in claim 13, wherein the e-mail system of the recipient places the e-mail into an inbox of the recipient only if a weighting and status table has been transmitted.

16. The method recited in claim 11, further comprising blocking the sender after a predetermined number of weightings by the sender are erroneous.

17. The method recited in claim 16, wherein the block is removable only by the sender personally contacting the recipient.

18. The method recited in claim 11, wherein the e-mail system includes the weighting and status table in a header of the e-mail.

19. The method recited in claim 11, further comprising automatically displaying the weighting selected by the sender to the recipient.

20. The method recited in claim 11, further comprising displaying the assessment of the recipient each time a new e-mail is composed in the form of at least one of a visual and acoustic signal.
